(19) United States
(12) Patent Application Publication
(10) Pub. No.: US 2025/0370136 A1
(43) Pub. Date: Dec. 4, 2025

(54) APPARATUS AND METHOD FOR MEASURING A DISTANCE BASED ON ADAPTIVE REGION OF INTEREST

(71) Applicant: SK hynix Inc., Gyeonggi-do (KR)

(72) Inventors: Ji Hee HAN, Gyeonggi-do (KR); Ju Hyun CHO, Gyeonggi-do (KR)

(21) Appl. No.: 18/934,245

(22) Filed: Nov. 1, 2024

(30) Foreign Application Priority Data
May 29, 2024 (KR) 10-2024-0069982

(51) Int. Cl. G01S 17/89; G01S 17/08

(52) U.S. Cl. CPC G01S 17/89; G01S 17/08

(57) ABSTRACT

A method for operating a LIDAR system includes dividing an entire valid measurement distance into a preset number of distance ranges, calculating a change value for laser positions applicable to the entire valid measurement distance, applying the change value to a reference value determining each of the distance ranges to reestablish each of the distance ranges, setting at least one region of interest for each of the reestablished distance ranges, and collecting depth data from the at least one region of interest.

### CROSS-REFERENCE TO RELATED APPLICATIONS

This patent application claims the benefit of priority under 35 U.S.C. § 119 (a) to Korean Patent Application No. 10-2024-0069982, filed on May 29, 2024, the entire disclosure of which is incorporated herein by reference.

### TECHNICAL FIELD

One or more embodiments of the present disclosure described herein relate to a LIDAR system, and more particularly, to a device and a method for error correction in the LiDAR system.

### BACKGROUND

Humans are good at inferring a relative depth, a distance, and a size of an object (i.e., a target or subject) in front based on information collected through both eyes. In the case of an image system, data on 2D images is collected, so there is a limit to obtaining 3D data. When two image sensors are used in a three-dimensional arrangement like human eyes, depth data can be extracted, but there are limits to accuracy of the distance and dependence on the surrounding illumination.

LIDAR stands for light detection and ranging. The LiDAR is a technique for detecting a distance by measuring a time it takes for light emitted at the object via a laser to return. A wavelength used in a LIDAR device may vary depending on an application. Depth data obtained through the LiDAR device can allow depth measurements to be made regardless of lighting conditions. By combining pulses of light emitted at the object and reflected back with precise timing measurements, the distance to the object could be calculated.

### BRIEF DESCRIPTION OF THE DRAWINGS

The description herein makes reference to the accompanying drawings wherein like reference numerals refer to like parts throughout the figures.

FIG. 1 illustrates a LIDAR system according to an embodiment of the present disclosure.

FIG. 2 illustrates a region of interest and a common region of interest set according to a distance in a LIDAR system according to an embodiment of the present disclosure.

FIG. 3 illustrates a change in laser position in a LIDAR system according to an embodiment of the present disclosure.

FIG. 4 illustrates an operating method of a LIDAR system according to an embodiment of the present disclosure.

FIG. 5 illustrates a range that distinguishes the entire valid measurement distance in a LiDAR system according to one embodiment of the present disclosure.

FIG. 6 illustrates an effective offset of a LIDAR system according to an embodiment of the present disclosure.

FIG. 7 illustrates a change value according to distance in a LIDAR system according to an embodiment of the present disclosure.

FIG. 8 illustrates accuracy of depth data in a LiDAR system according to an embodiment of the present disclosure.

FIG. 9 illustrates a method of resetting a range in a LIDAR system according to an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., an FPGA or a general-purpose processor executing software to operate in a manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine,’ ‘circuitry’ or ‘logic’ also covers an implementation of merely a processor or multiple processors or a portion of a processor and its (or their) accompanying software and/or firmware. The term ‘machine,’ ‘circuitry’ or ‘logic’ also covers, for example, and if applicable to a particular claim element, an integrated circuit for a storage device.

As used herein, the terms ‘first,’ ‘second,’ ‘third,’ and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the present disclosure can provide an apparatus and a method capable of improving accuracy of distance measurement in a LIDAR system.

An embodiment of the present disclosure can perform error correction corresponding to a laser position in a LIDAR system for calculating a distance or a depth to an object based on data collected from a preset region of interest according to a distance, to thereby improve the accuracy of distance measurement and reduce a processing burden.

Further, to improve operating efficiency of a LIDAR system according to an embodiment of the present disclosure, a reference value for determining a distance range in which the number of regions of interest varies can be corrected, thereby improving the accuracy of distance or depth.

An embodiment of the present disclosure can provide a method for operating a LIDAR system, including dividing an entire valid measurement distance into a preset number of distance ranges; calculating a change value for laser positions applicable to the entire valid measurement distance; applying the change value to a reference value determining each of the distance ranges to reestablish each of the distance ranges; setting at least one region of interest for each of the reestablished distance ranges; and collecting depth data from the at least one region of interest.

In the method, the number of the at least one region of interest can decrease, as a distance among the reestablished distance ranges increases.

The change value can include a difference between an arrangement distance of a reflector having a Lambertian reflectance of 80% or more and a measurement distance regarding the arrangement distance classified based on at least one preset threshold in the entire valid measurement distance.

The change value can be associated with values that the laser positions move in a common direction in a common region of interest for the entire valid measurement distance, the common region of interest determined as a region in which at least one laser position is included from the preset number of distance ranges.

The calculating the change value can include determining, as a group, some laser positions of which the change value among the laser positions is within a preset deviation; and calculating a second average value of the change values of the some laser positions corresponding to the group.

The applying the change value can include calculating an adjusted reference value by adding the second average value to the reference value; and reestablishing each of the distance ranges based on the adjusted reference value.

In the method, the number of the distance ranges can be three, and the reference value can include two criteria for determining three distance ranges.

The change value can be applied equally to the two criteria.

The change value can be less at a long distance range among the distance ranges than at a short distance range among the distance ranges.

Another embodiment of the present disclosure can provide a LIDAR system, including an emitter configured to emit light; a receiver configured to receive reflected light corresponding to the light; and a control circuit configured to output depth data based on reflected light corresponding to a preset number of regions of interest determined according to a distance among the reflected light collected through the receiver. The distance can be adjusted based on a change value for laser positions for emitting the light.

The control circuit can be configured to control the emitter based on at least one information among a frequency or wavelength, an amplitude, and a time of the light; and control the receiver based on the information used for the emitter.

The control circuit can be configured to transmit information regarding the preset number of regions of interest to the receiver. The receiver can be configured to transmit sensed data corresponding to the preset number of regions of interest to the control circuit.

The control circuit can be configured to receive sensed data corresponding to all regions of interest from the receiver; and process some sensed data corresponding to the preset number of regions of interest selected among all regions of interest.

The control circuit can be configured to divide the entire valid measurement distance into a preset number of distance ranges; calculate the change value for the laser positions applicable to the entire valid measurement distance; apply the change value to a reference value determining each of the distance ranges to reestablish each of the distance ranges; set at least one region of interest for each of reestablished distance ranges; and collect depth data from the at least one region of interest.

The change value can include a difference between an arrangement distance of a reflector having a Lambertian reflectance of 80% or more and a measurement distance regarding the arrangement distance classified based on at least one preset threshold in the entire valid measurement distance.

The control circuit can be configured to transmit the light to the reflector through the emitter; and collect the reflected light from the reflector through the receiver.

The control circuit can be configured to calculate the change value including a difference between the arrangement distance in a common area of interest and a measured distance measured through the reflected light; determine, as a group, some laser positions of which the change value among the laser positions is within a preset deviation; and calculate a second average value of the change values of the some laser positions corresponding to the group.

The control circuit can be configured to calculate an adjusted reference value by adding the second average value to the reference value; and reestablish each of the distance ranges based on the adjusted reference value.

In the LiDAR system, the number of the distance ranges can be three, and the reference value can include two criteria for determining three distance ranges.

The change value can be applied equally to the two criteria.

These and other features and advantages of the invention will become apparent from the detailed description and the accompanying drawings of embodiments of the present disclosure. Embodiments will now be described with reference to the accompanying drawings, wherein like numbers reference like elements.

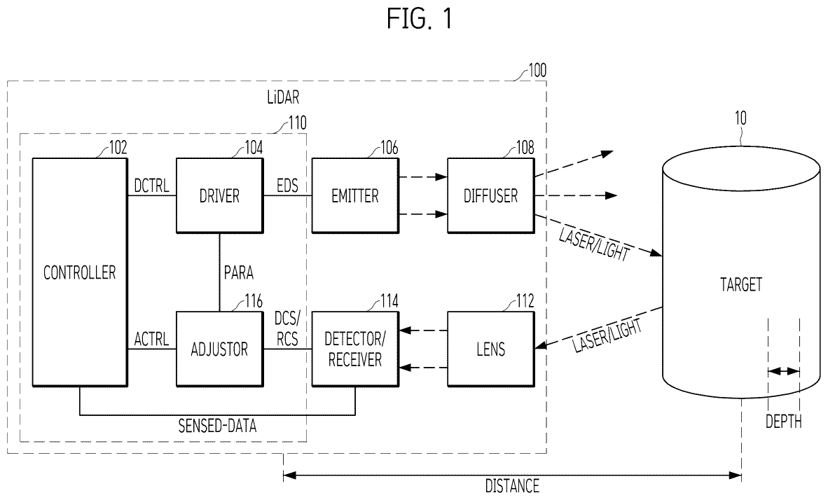

FIG. 1 illustrates a LIDAR system 100 according to an embodiment of the present disclosure.

Referring to FIG. 1, the LiDAR system 100 can include a control circuit 110, an emitter 106, and a detector/receiver 114. According to an embodiment, the LiDAR system 100 can further include a diffuser 108 and a lens 112.

The emitter 106 can include a plurality of emitting elements that individually emit lasers or light. The emitting element can include a pulsed light source such as an LED or a laser element (e.g., a vertical cavity surface emitting laser, VCSEL). The lasers or light emitted from the emitter 106 can be spread over a wider range through the diffuser 108. The detector/receiver 114 can include a plurality of detecting elements that individually receive or detect lasers or light. For example, the plurality of detecting elements in the detector/receiver 114 can be aligned in row and column directions, such as an array of single photon detectors such as a Single Photon Avalanche Diode (SPAD), an avalanche photodiode (APD), a PIN diode, or etc. The detector/receiver 114 can be aligned so that the lasers or light reaching the detector/receiver 114 is incident through the lens 112. The diffuser 108 and the lens 112 can include a plurality of optical components. The diffuser 108 and the lens 112 can be used to improve performance of the emitter 106 and the detector/receiver 114.

The control circuit 110 can output an emitter drive signal EDS that controls the emitter 106, or a detection control signal DCS or a reception control signal RCS that controls the detector/receiver 114. The control circuit 110 can receive and process sensed (or detected) data (SENSE-DATA) from the receiver 114. Here, the processing of the sensed data can include data processing, conversion, etc., such as correcting data, converting data into a specific format, or removing a noise included in data.

According to an embodiment, the control circuit 110 can include a controller 102, a driver 104, and an adjustor 116. The controller 102 can output a driver control signal DCTRL for controlling the driver 104. The driver 104 under the control of the controller 102 can output the emitter drive signal EDS so that the emitter 106 can emit lasers or light having a specific wavelength at a specific time. In addition, the driver 104 can transmit information or parameters PARA regarding the lasers or light, emitted by the emitter 106, to the adjustor 116.

The controller 102 can output a controller control signal ACTRL used for controlling the adjustor 116. The adjustor 116 can output the detection control signal DCS or the reception control signal RCS under the control of the controller 102. The adjustor 116 can control a temporal or spatial operation range of the receiver 114 based on the information or parameters PARA about the lasers or light, which can be transmitted by the driver 104. The detection control signal DCS or the reception control signal RCS can include information showing the temporal or spatial operation range of the receiver 114, which can be determined by the adjustor 116.

In response to the detection control signal DCS or the reception control signal RCS output from the adjustor 116, the receiver 114 can output the sensed data to the controller 102. The controller 102 can verify a validity of the sensed data, remove a noise included in the sensed data, or correct the sensed data.

Based on the sensed data collected through the receiver 114, the controller 102 can calculate a distance between the LiDAR system 100 and a target (i.e., an object or subject) 10. For example, the controller 102 can include a circuit, processor, or logic that is configured to measure or calculate a flight time of the lasers or light from the emitter 106 to the target 10 and from the target 10 to the receiver 114, based on a direct or indirect Time of Flight (ToF) measurement technique. In addition, if the target 10 is a three-dimensional object, the controller 102 can also calculate a depth according to a curvature, a slope, etc. of surfaces of the target 10. Here, the distance or depth can include a physical distance between a specific location (e.g., a specific point on the target 10) in which the lasers or light can be reflected and a location of the LiDAR system 100 emitting the lasers or light. The LiDAR system 100 can be used to calculate the distance or depth based on a time taken for the lasers or light which can be output from plural emitting elements in the emitter 106 and input through the receiver 114 after reflected from multiple points on the target 10.

According to an embodiment, an intensity of the lasers or light emitted by the plural emitting elements in the emitter 106 and spread through the diffuser 108 can be adjusted to a level that can provide or guarantee eye safety for people around the LiDAR system 100.

According to an embodiment, the plural emitting elements in the emitter 106 can be individually controlled through multiple drive units in the driver 104. The plural detecting elements in the receiver 114 can also be selectively controlled by the detection control signal DCS or the reception control signal RCS.

According to an embodiment, the driver 104 can control a modulation frequency, a timing, and an amplitude of the lasers or light emitted by the plural emitting elements in the emitter 106.

According to an embodiment, the LiDAR system 100 can set a region of interest (ROI) in response to a distance from the target 10. There are several methods for setting or establishing the region of interest (ROI) in the LiDAR system 100.

For example, the LiDAR system 100 can set or establish a static region of interest (ROI). The static region of interest (ROI) scheme can include manually setting or establishing the region of interest when needed. This scheme can be useful when an operating environment of the LiDAR system 100 does not change over time. For example, when it is desired to monitor only a specific structure or area using the LiDAR system 100, the static region of interest (ROI) scheme can be used.

The LiDAR system 100 can set or establish a dynamic region of interest (ROI). The Dynamic region of interest (ROI) scheme can be used when the region of interest can change over time. In this case, an image processing technique can be used to dynamically update or change the region of interest. For example, when the LiDAR system 100 tracks a moving vehicle, the region of interest (ROI) can be dynamically adjusted according to a location of the moving vehicle.

In addition, the LiDAR system 100 can set or establish the region of interest (ROI) based on a threshold value or reference value. For example, the region of interest (ROI) can be determined based on a threshold value regarding a specific color or brightness in an image. This method might be simple. However, for accuracy, the threshold value may need to be adjusted based on changes in environmental conditions while the LiDAR system 100 operates.

In addition, the LiDAR system 100 can set or establish the region of interest (ROI) based on object detection. For example, a machine learning or deep learning model can be used to detect an object in an image and set or establish an area around a detected object in the image as the region of interest (ROI).

In addition, the LiDAR system 100 can set or establish the region of interest (ROI) using depth data. When analyzing data collected or processed by the LiDAR system (100), only objects at a specific depth range can be set as a region of interest (ROI). For example, when only objects at a certain distance are to be analyzed, only data points corresponding to a depth range can be selected and set as the region of interest (ROI).

According to an embodiment, when the LiDAR system 100 sets or establishes a dynamic region of interest (ROI), the threshold value or reference value can be set differently depending on a distance. This is because the intensity of the reflection of the lasers or light decreases as the distance between the lidar system 100 and the target 10 increases. Because a strength or intensity of the lasers reflected back becomes weaker as the distance increases, it may be necessary to adjust the threshold value depending on the distance for compensation to properly reflect this phenomenon.

According to an embodiment, in order to adjust the threshold value or reference value depending on a distance, an offset can be calculated through a test on the LiDAR system 100. In addition, the sensed data of the LiDAR system 100 generated in real time can be analyzed to measure intensity of reflection signals (i.e., reflected lasers or light) depending on the distance. The threshold value or reference value can be dynamically adjusted based on this operation.

Hereinafter, methods and devices for improving accuracy of distance or depth data recognized or calculated by the LiDAR system 100 are described.

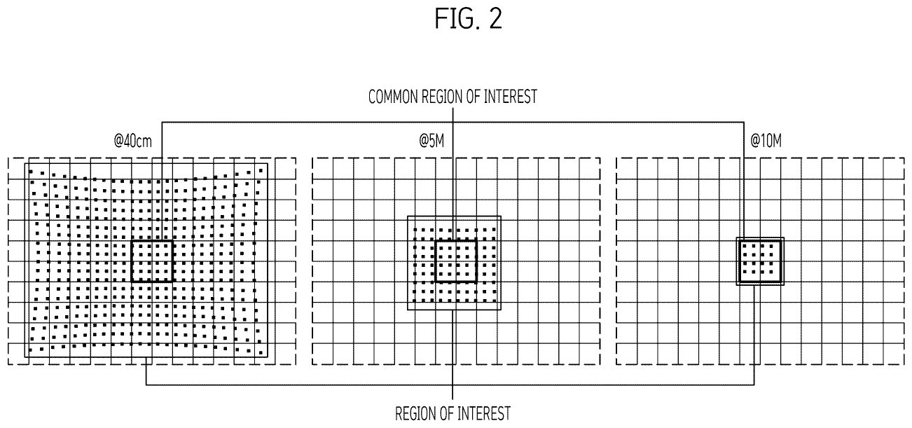

FIG. 2 illustrates a region of interest and a common region of interest set according to a distance in a LIDAR system according to an embodiment of the present disclosure.

Referring to FIGS. 1 and 2, laser positions (Laser Dot) in the LIDAR system 100 can be checked by placing a reflector having a Lambertian reflectance of 80% or more as the target 10 at an arbitrary distance. Herein, the laser positions (Laser Dot) can correspond to positions of plural emitting elements included in the transmitter 106 described in FIG. 1. FIG. 2 shows the laser positions (Laser Dot) when the reflector is located at 40 cm, 5 m, and 10 m away from the LiDAR system 100.

First, the region of interest can be set as a region including the laser positions (Laser Dot). Obtaining or processing sensed data in an area that does not include laser positions might not be helpful in calculating a distance or depth of the target 10. As the distance increases (from 40 cm to 10 m), a valid range where the laser positions are reflected from the reflector in the entire area can decrease due to a field of view (FOV) of the LiDAR system 100. For example, at a distance of 40 cm, sensed data collected from 120 (=12×10) macro pixels can be valid. But, at a distance of 10 m, sensed data collected from 4 macro pixels can be valid.

When each macro pixel is set as a region of interest, the number of regions of interest from which valid data can be obtained varies depending on the distance. Moreover, a macro pixel from which the LIDAR system 100 can produce or output valid distance or depth data in an entire valid measurement distance can be set or established as a common region of interest. Herein, the entire valid measurement distance can be estimated or determined from the minimum valid measurement distance to the maximum valid measurement distance of the LiDAR system 100.

According to an embodiment, if error correction can be performed for each region of interest from which valid data can be obtained at every distance, the LiDAR system 100 can produce accurate distance or depth data. However, this method would require enormous resources for the error correction. Thus, to improve resource efficiency and accuracy of distance or depth data, an embodiment of the present disclosure can provide a device or a method for performing appropriate error correction according to a distance.

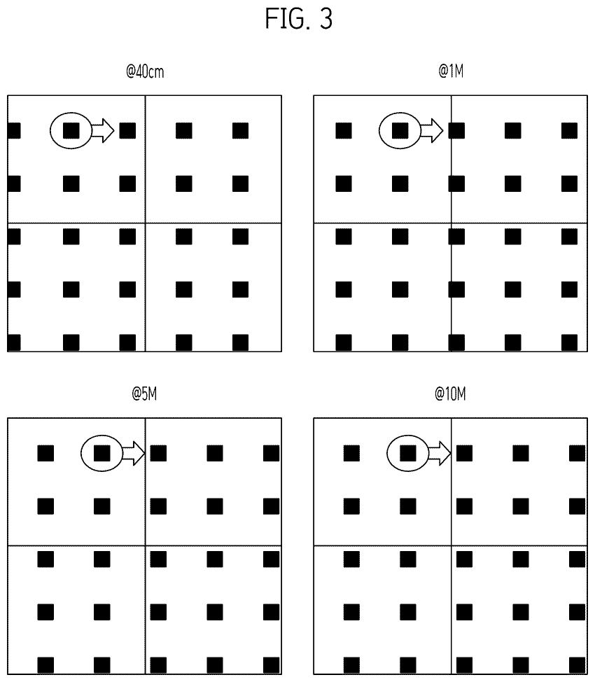

FIG. 3 illustrates a change in laser position in a LIDAR system according to an embodiment of the present disclosure. Specifically, FIG. 3 illustrates variation of laser positions with a distance in the common region of interest described in FIG. 2. FIG. 3 shows the laser positions (Laser Dot) when the reflector is located at 40 cm, 1 m, 5 m, and 10 m away from the LiDAR system 100.

In accordance with an embodiment, when comparing the laser positions (Laser Dot) at each distance of 40 cm, 1 m, 5 m, and 10 m, a laser position (circled in FIG. 3) moves in an x-axis direction. These variations of laser positions might be not absolute. For example, in a LIDAR system using a Vertical-Cavity Surface-Emitting Laser (VCSEL) technology, the variation of laser positions (Laser Dot) corresponding to a different depth could be determined by several physical principles and a design of the LiDAR system.

For example, in the LiDAR system using VCSELs, the laser positions (Laser Dot) can vary depending on a design of optical elements (lenses, mirrors, etc.) such as the diffuser 108 or lens 112 described in FIG. 1 and internal configuration of the LiDAR system. The VCSEL itself might not move the laser position (Laser Dot) in a specific direction depending on a depth or distance but can emit lasers or light in a specific direction. However, because the optical elements such as the diffuser 108 or lens 112 in the LiDAR system 100 can modify a path of the lasers or light, so that a change in the laser positions (Laser Dot) can occur in a specific direction.

Because the laser positions (Laser Dot) change depending on each distance or depth, it is necessary to set or establish a region of interest (ROI) that can track the change in the laser positions (Laser Dot) in which the lasers or light can be emitted, to obtain or extract accurate distance or depth data. As described in FIG. 2, a macro pixel that can obtain valid data over the entire valid measurement distance can be set or established as the common region of interest.

On the other hand, if the change in the laser positions (Laser Dot) is tracked from a region of interest that changes at each distance rather than the common region of interest, a noise can increase by as much as the number of regions of interest (ROI) increases, so that the accuracy of distance or depth data can decrease.

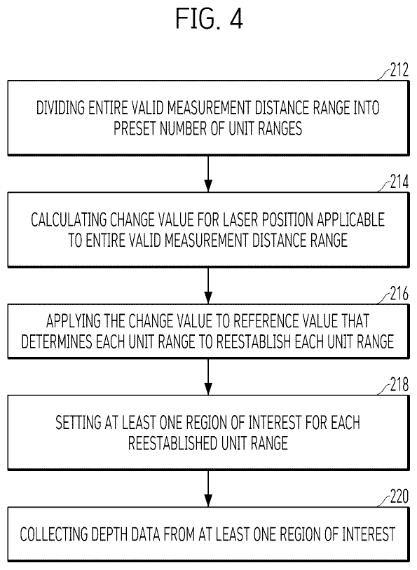

FIG. 4 illustrates an operating method of a LIDAR system according to an embodiment of the present disclosure.

Referring to FIG. 4, the operation method of the LiDAR system can include dividing the entire effective measurement distance into a preset number of distance ranges (at operation 212), calculating a change value for laser positions applicable to the entire effective measurement distance (at operation 214), reestablishing each of the distance ranges by applying the change value to a reference value used to determine each of the distance ranges (at operation 216), setting at least one region of interest for each of the reset ranges (at operation 218), and collecting depth data from the at least one region of interest (at operation 220).

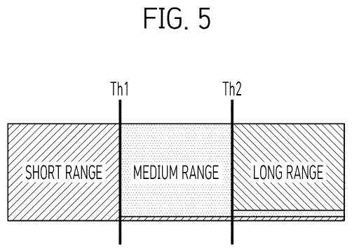

According to an embodiment, dividing the entire effective measurement distance into the preset number of distance ranges (the operation 212) can be performed to improve resource efficiency of the LIDAR system. Tracking the change in the laser positions (Laser Dot) in a region of interest that changes for every measurement distance may have a disadvantage of increasing a noise in measured data. For example, the entire effective measurement distance of the LiDAR system can be 0 to 12 m. The entire effective measurement distance of 0 to 12 m can be broadly divided into three distance ranges. The three distance ranges can be a short range, a medium range, and a long range. This will be described later with reference to FIG. 5. Depending on the embodiment, how many distance ranges the entire effective measurement distance is divided into can vary.

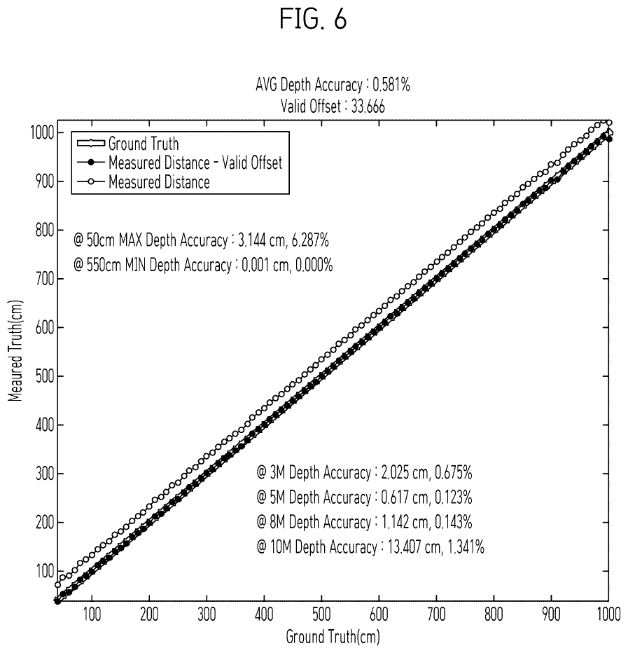

Depending on the embodiment, the LiDAR system can calculate a change value for the laser positions, which is applicable to the entire effective measurement distance for error correction (the operation 214). This can be extracted based on a common region of interest. This will be described later with reference to FIGS. 6 to 8.

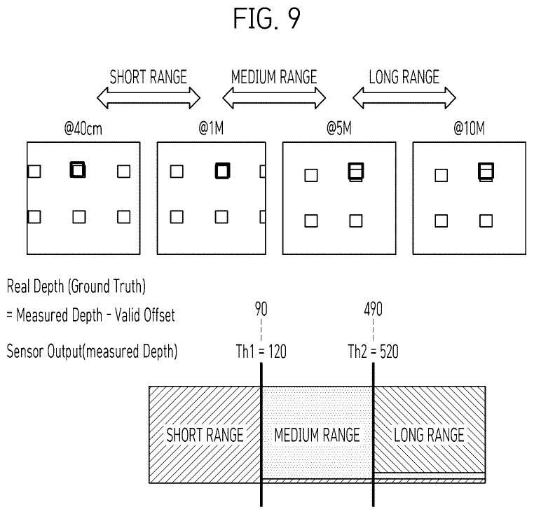

Depending on the embodiment, the LiDAR system can reset or reestablish each distance range by applying the change value to the reference value that determines each distance range (the operation 216). Because the reestablished distance range can reflect the change value for the laser positions, the LiDAR system can calculate more accurate distance or depth data. Resetting or reestablishing each distance range will be described later with reference to FIG. 9.

When it is plausible that the LiDAR system has reset the distance range to reflect the change value for the laser positions, the LiDAR system can dynamically or adaptively set or establish the region of interest as described in FIG. 1 (the operation 218). The region of interest can be at least one region. After setting or establishing the region of interest, the LiDAR system can collect depth data from the established region of interest (the operation 220).

FIG. 5 illustrates a range that distinguishes the entire valid measurement distance in a LIDAR system according to an embodiment of the present disclosure.

Referring to FIG. 5, the LiDAR system can divide the entire effective measurement distance into three sections or distance ranges of the short distance, the medium distance, and the long distance, and set a region of interest (ROI) corresponding to each section or distance range. There can be at least one criterion Th1, Th2 for dividing each section or distance range. For example, a distance from the minimum effective measurement distance (e.g., 0.4 m) to the first criterion Th1 can belong to the short distance, a distance from the first criterion Th1 to the second criterion Th2 can belong to the medium distance, and a distance from the second criterion Th2 to the maximum effective measurement distance (e.g., 10 m or 12 m, etc.) can belong to the long distance. Depending on the embodiment, the number of sections or distance ranges divided from the entire effective measurement distance and the number of criteria used to determine the sections or distance ranges can vary.

The number of regions of interest (ROI) can be different for each section or distance range because an amount of change in the laser positions (Laser Dot) is different for each section or distance range. In the short range, the amount of change in the laser positions (Laser Dot) can be large, so a larger number of regions of interest can be set. On the other hand, in the long range, the amount of change in the laser positions (Laser Dot) can be small, so the number of regions of interest can be reduced.

The change in the laser positions in the LiDAR system can occur due to a design of the optical elements. For example, due to a specific optical element design, when the lasers or light reflected from an object reaches the receiver or sensor again, the reflected lasers or light can reach a different position on the receiver or sensor depending on a depth or distance of the object. This might be similar to a principle of measuring or calculating distance information using a type of triangulation method in three-dimensional space. The change in the laser positions can be estimated depending on the design of the LiDAR system.

To improve the accuracy of the distance or depth measured by the LiDAR system, it is necessary to adjust at least one criterion Th1, Th2 used for dividing the entire effective measurement distance into plural sections or distance ranges. To this end, the LiDAR system can apply an offset to the at least one reference Th1, Th2 by calculating the offset that represents a difference between an actual distance or depth (Ground Truth) and a distance or depth measured by the LiDAR system (Measured Depth).

FIG. 6 illustrates an effective offset of a LIDAR system according to an embodiment of the present disclosure. Specifically, FIG. 6 shows test results for the LiDAR system, and the values shown in the results may vary depending on the LiDAR system. The values shown in FIG. 6 are not absolute and can vary depending on the embodiment.

Referring to FIG. 6, by positioning a test target at preset intervals from 0 cm to 1000 cm (=10 m), the difference between the actual distance or depth (Ground Truth) and the distance or depth measured by the LiDAR system (Measured Depth) can be checked or tracked. The LiDAR system can actually output a measured result (Measured Truth) with an offset added to the actual distance or depth (Ground Truth).

Ideally, the offset can be expected to be the same for an entire measured distance range from 0 cm to 1000 cm (=10 m). But, in an actual test for the LiDAR system, the offset may vary depending on a distance. Referring to FIG. 6, different accuracies are shown at various distances (e.g., 50 cm, 3 m, 5 m, 550 cm, 8 m, 10 m), and the offsets can also be different. When each offset is applied, processing loads of the LiDAR system can significantly increase. Further, because noises included in the measured distances or depths for the entire measured distance can be different from each other, the reliability of each offset might not be guaranteed. Therefore, according to an embodiment, when a common valid offset applicable to the entire measured distance is calculated and applied, the resource efficiency of the LiDAR system can be improved.

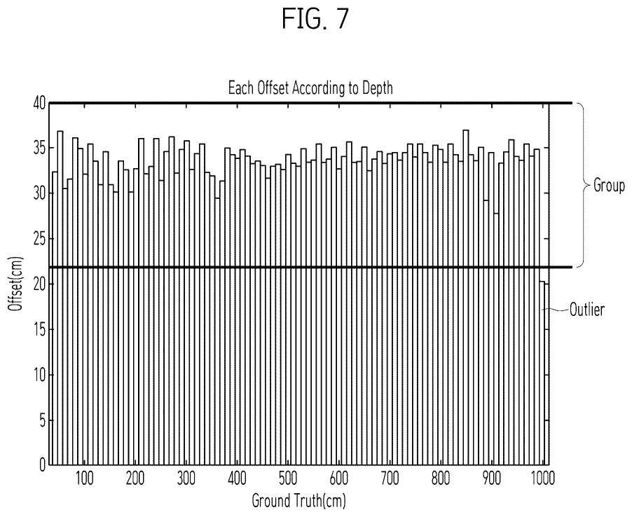

FIG. 7 illustrates a change value according to distance in a LIDAR system according to an embodiment of the present disclosure. Specifically, FIG. 7 shows offsets, which are differences between distances or depths (Measured Depth) measured by a LIDAR system and actual distances or depths (Ground Truth), corresponding to distances in the entire measurement distance range. Depending on the embodiment, the change value or offset of the LiDAR system can be different. Even with a same LiDAR system, a difference in the change value or offset can occur depending on a test or operation environment. The numerical value shown in FIG. 7 might be not absolute, and the numerical value can vary depending on the embodiment.

Referring to FIG. 7, an offset may be displayed corresponding to the distance at the entire measurement distance from 0 cm to 1000 cm (=10 m). Most of the test results or results in the use environment of the entire measurement distance may have different offsets at almost all distances or depths.

Depending on an embodiment, the LiDAR system can group the entire offsets according to a preset criterion to obtain a valid offset. For example, after calculating a first average value of the entire offsets, values within ±30% (i.e., deviation) from the first average value can be included in the group. An offset that does not fall within the group (e.g., a range of ±30% from the first average value) can be determined as an outlier. Depending on the embodiment, the LiDAR system can determine that offsets determined as outliers contain relatively more noise. Thereafter, the LiDAR system can calculate a second average value from the group that includes values within the range of ±30% from the first average value. For example, the first average value of the offsets described in FIG. 7 can be 33.528. The values within the range of ±30% of the first average value can be located between 23.467 and 43.586. When the second average value is calculated from only offsets that fall between 23.467 and 43.586 among the entire offsets, a calculated second average value can be 33.66. Herein, the calculated second average value of 33.66 can be determined as the valid offset.

According to an embodiment, the LiDAR system can use a mean value of the entire offsets, instead of the first average value of the entire offsets, when it is determined that there are noises in at least some of the entire measurement distance.

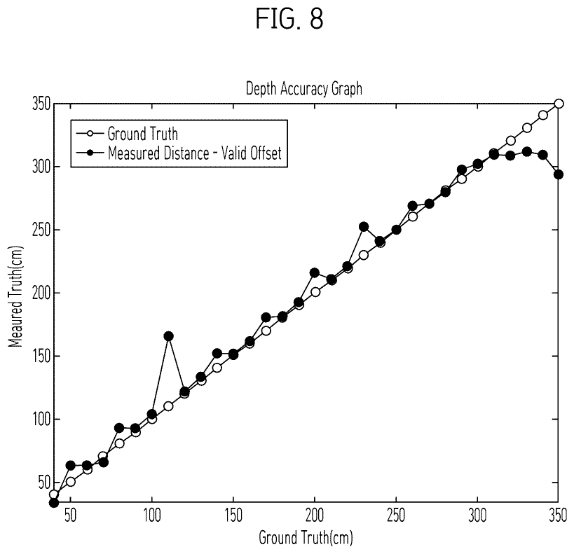

FIG. 8 illustrates accuracy of depth data in a LIDAR system according to an embodiment of the present disclosure. Specifically, FIG. 8 illustrates the accuracy of distance or depth data through a difference between the actual distance or depth (Ground Truth) and a correction value (=Measured Distance−Valid Offset) which is obtained by applying valid offsets (Valid Offset) to the distance or depth (Measured Depth) measured by the LiDAR system at some of the entire measured distance range.

Referring to FIG. 8, it can be confirmed that the difference between the actual distance or depth (Ground Truth) and the correction value (=Measured Distance−Valid Offset) obtained by applying the valid offsets to the actual distance or depth (Ground Truth) can be reduced at every measured distance from 40 cm to 350 cm. There are examples where the difference between the correction value (=Measured Distance-Valid Offset) and the actual distance or depth (Ground Truth) increases rapidly due to a noise at some distances, but such values can be easily corrected through a post error correction or post compensation process in the LiDAR system. In this way, by reducing the difference between the correction value (=Measured Distance-Valid Offset) and the actual distance or depth (Ground Truth) at most distances in the entire measured distance range of the LiDAR system, the accuracy of the distance or depth data output by the LiDAR system can be improved.

FIG. 9 illustrates a method of resetting a range in a LIDAR system according to an embodiment of the present disclosure.

Referring to FIG. 9, the entire measurement distance range of the LiDAR system can be divided into three distance ranges of the short distance, the medium distance, and the long distance based on the change value of the laser positions (Laser Dot). In an initial setting, the first criterion Th1 used for distinguishing the short distance and medium distance can be set to 120 cm, and the second criterion Th2 used for distinguishing the medium distance and long distance can be set to 490 cm.

As described in FIGS. 6 to 8, the LiDAR system can calculate offsets for the entire measurement distance range and determine a common offset or effective offset. For example, the effective offset can be calculated as 30 cm. The LiDAR system can apply the effective offset to both the first criterion Th1 and the second criterion Th2. The first criterion Th1 can be adjusted from 90 cm to 120 cm, and the second criterion Th2 can be adjusted from 490 cm to 520 cm. Therefore, the first criterion Th1 and the second criterion Th2 that divide the entire measurement distance of the lidar system into three distance ranges of the short, medium, and long ranges are different, and the three distance ranges of the short, medium, and long ranges can be set or established in response to the change value of the laser positions (Laser Dot). Through this procedure, the LiDAR system can output more accurate distance or depth data.

The above-described laser position (Laser Dot) correction or compensation method based on the effective offset can be simpler, faster, and more resource-efficient than other various algorithms that can be used to correct the laser positions in a VCSEL (Vertical-Cavity Surface-Emitting Laser)-based LiDAR system. Here, various algorithms which are generally borrowed from a technical field such as image processing, pattern recognition, and machine learning, can be designed to accurately identify and correct the laser positions.

For example, a geometric transformation such as the Affine transformation and the Perspective transformation can be used for modeling of changes in the laser positions, which mathematically identifies a regularity of the changes in the laser positions, and estimates and corrects the actual positions based on the regularity. In addition, the Kalman filter, which is an algorithm widely used for state estimation in dynamic systems, can be used to estimate and correct the laser positions that change over time. Machine learning and deep learning such as CNN (Convolutional Neural Networks) and RNN (Recurrent Neural Networks) can be used for the purpose of object recognition, position estimation, etc., and can be used to accurately estimate and correct the laser positions through a learned model. In addition, the Hough transform, which is used to recognize straight lines, circles, or other types of patterns in an image, can be used to track and correct a path or position of at least one laser emitted from the LiDAR system. Object tracking algorithms such as MeanShift, CAMShift, and Particle Filter can be used to track a position of an object over time, as well as to track and compensate for changes in the laser positions (Laser Dot).

The method of compensating for the laser positions (Laser Dot) using the effective offset can also be applied to several algorithms mentioned above. While several algorithms mentioned above use more resources, applying the method of compensating for the laser position (Laser Dot) using the effective offset to several algorithms mentioned above can reduce a processing and computational amount of the LiDAR system.

As above described, a LIDAR system according to an embodiment of the present disclosure can reduce a noise by setting different regions of interest according to a distance.

In addition, a LIDAR system according to an embodiment of the present disclosure can improve the accuracy of distance or depth by differentiating the number of regions of interest according to a distance.

Further, a LIDAR system according to an embodiment of the present disclosure can set or establish adaptive regions of interest to improve efficiency of resource usage.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the present teachings have been illustrated and described with respect to the specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A method for operating a LIDAR system, the method comprising:
dividing an entire valid measurement distance into a preset number of distance ranges;
calculating a change value for laser positions applicable to the entire valid measurement distance;
applying the change value to a reference value determining each of the distance ranges to reestablish each of the distance ranges;
setting at least one region of interest for each of the reestablished distance ranges; and
collecting depth data from the at least one region of interest.

2. The method according to claim 1, wherein a number of the at least one region of interest decreases as a distance among the reestablished distance ranges increases.

3. The method according to claim 1, wherein the change value includes a difference between an arrangement distance of a reflector having a Lambertian reflectance of 80% or more, and a measurement distance regarding the arrangement distance classified based on at least one preset threshold in the entire valid measurement distance.

4. The method according to claim 1, wherein the change value is associated with values that the laser positions move in a common direction in a common region of interest for the entire valid measurement distance, the common region of interest determined as a region in which at least one laser position is included from the preset number of distance ranges.

5. The method according to claim 1, wherein the calculating the change value comprises:
determining, as a group, some laser positions of which the change value among the laser positions is within a preset deviation; and
calculating a second average value of the change values of the some laser positions corresponding to the group.

6. The method according to claim 5, wherein the applying the change value comprises:
calculating an adjusted reference value by adding the second average value to the reference value; and
reestablishing each of the distance ranges based on the adjusted reference value.

7. The method according to claim 1, wherein a number of the distance ranges is three, and the reference value includes two criteria for determining three distance ranges.

8. The method according to claim 7, wherein the change value is applied equally to the two criteria.

9. The method according to claim 1, wherein the change value is less at a long distance range among the distance ranges than at a short distance range among the distance ranges.

10. A LIDAR system comprising:
an emitter configured to emit light;
a receiver configured to receive reflected light corresponding to the light; and
a control circuit configured to output depth data based on reflected light corresponding to a preset number of regions of interest, determined according to a distance, among the reflected light collected through the receiver,
wherein the distance is adjusted based on a change value for laser positions for emitting the light.

11. The LiDAR system according to claim 10, wherein the control circuit is configured to:
control the emitter based on at least one information among a frequency or wavelength, an amplitude, and a time of the light; and
control the receiver based on the information used for the emitter.

12. The LiDAR system according to claim 10,
wherein the control circuit is configured to transmit information regarding the preset number of regions of interest to the receiver, and
wherein the receiver is configured to transmit sensed data corresponding to the preset number of regions of interest to the control circuit.

13. The LiDAR system according to claim 10, wherein the control circuit is configured to:
receive sensed data corresponding to all regions of interest from the receiver; and
process some sensed data corresponding to the preset number of regions of interest selected among all regions of interest.

14. The LiDAR system according to claim 10, wherein the control circuit is configured to:
divide the entire valid measurement distance into a preset number of distance ranges;
calculate the change value for the laser positions applicable to the entire valid measurement distance;
apply the change value to a reference value determining each of the distance ranges to reestablish each of the distance ranges;
set at least one region of interest for each of the reestablished distance ranges; and
collect depth data from the at least one region of interest.

15. The LiDAR system according to claim 14, wherein the change value includes a difference between an arrangement distance of a reflector having a Lambertian reflectance of 80% or more, and a measurement distance regarding the arrangement distance classified based on at least one preset threshold in the entire valid measurement distance.

16. The LiDAR system according to claim 15, wherein the control circuit is configured to:
transmit the light to the reflector through the emitter; and
collect the reflected light from the reflector through the receiver.

17. The LiDAR system according to claim 16, wherein the control circuit is configured to:
calculate the change value including a difference between the arrangement distance in a common area of interest and a measured distance measured through the reflected light;
determine, as a group, some laser positions of which the change value among the laser positions is within a preset deviation; and
calculate a second average value of the change values of the some laser positions corresponding to the group.

18. The LiDAR system according to claim 17, wherein the control circuit is configured to:
calculate an adjusted reference value by adding the second average value to the reference value; and
reestablish each of the distance ranges based on the adjusted reference value.

19. The LiDAR system according to claim 18, wherein a number of the distance ranges is three, and the reference value includes two criteria for determining three distance ranges.

20. The LiDAR system according to claim 19, wherein the change value is applied equally to the two criteria.
